(19) United States
(12) Patent Application Publication
(10) Pub. No.: US 2018/0128239 A1
(43) Pub. Date: May 10, 2018

(54) PUMPING DEVICE FOR A WASTE HEAT RECOVERY APPARATUS IN A MOTOR VEHICLE

(71) Applicant: Mahle International GmbH, Stuttgart (DE)

(72) Inventors: Jochen Eggler, Ostfildern (DE); Alfred Elsaesser, Keltern (DE); Ladisch Helge, Stuttgart (DE); Christian Maisch, Kirchheim (DE); Sascha Senjic, Stuttgart (DE)

(73) Assignee: Mahle International GmbH, Stuttgart (DE)

(21) Appl. No.: 15/514,344

(22) PCT Filed: Jul. 31, 2015
(86) PCT No.: PCT/EP2015/067704

§ 371 Date: Dec. 13, 2017

(30) Foreign Application Priority Data
Sep. 25, 2014 (DE) 10 2014 219 487.3

(51) Int. Cl. F03C 1/06; F04B 1/12; F04B 11/00

(52) U.S. Cl. CPC F03C 1/06; F02G 5/00; F04B 11/0091; F04B 1/12

(57) ABSTRACT

A pumping device may include a pump housing partially delimiting a working chamber, and a piston arranged therein, axially movable between first and second positions in which the working chamber has maximum and minimum volumes, respectively. The pumping device may include first and second fluid lines for introducing and discharging fluid to/from the working chamber, respectively. The first fluid line may be an annular fluid channel, fluidically connected to the working chamber via a breakthrough formed in the pump housing at an end face of the working chamber opposite the piston, running transversely to the axial direction at least in the area of the breakthrough. The second fluid line may open obliquely into the working chamber in an area of the second position, relative to the axial direction in an end face delimiting the working chamber towards the first fluid line. The pumping device may include first and second valves for fluid-tight closures of the first and second fluid lines, respectively, the second valve communicating fluidically with the working chamber directly.

### CROSS-REFERENCE TO RELATED APPLICATIONS

This application claims priority to International Patent Application No. PCT/EP2015/067704, filed on Jul. 31, 2015, and German Patent Application No. DE 10 2014 219 487.3, filed on Sep. 25, 2014, the contents of both of which are incorporated by reference in their entirety.

### TECHNICAL FIELD

The invention relates to a pumping device, in particular an axial piston pump, for a waste heat recovery apparatus in a motor vehicle.

### BACKGROUND

Waste heat recovery devices are used for recovering energy from a waste heat flow of an internal combustion engine of a motor vehicle. Waste heat recovery devices known from the prior art typically comprise a fluid cycle, for example, a so-called Clausius-Rankine cycle in which a working fluid circulates. Mechanical energy is obtained from the heat stored in the working medium by various changes in state in the working fluid to which this is subjected when flowing through the fluid cycle.

Pumping devices are used for transporting the working fluid, which for example can be implemented in the form of a so-called stroke or axial piston pump. Such a stroke or axial piston pump follows the principle of action of a displacement pump in which the so-called displacer in the form of a piston executes a translational stroke movement within a working volume.

Against this background U.S. Pat. No. 3,411,453 A and U.S. Pat. No. 4,486,152 A each disclose a pumping device having a working chamber in which a piston is arranged adjustably. A first fluid line is used to introduce a fluid into the working chamber and is fluidically connected to the working chamber by means of a breakthrough arranged on an end face of the working chamber opposite the piston. A first valve element for closing the first fluid line with respect to the working chamber is arranged in the area of the breakthrough. In addition, a second fluid line opens into the working chamber via which the fluid can again be discharged from the working chamber and specifically in the region of a position of the piston in which the working chamber has a minimal volume. A second valve element for closing the second fluid channel towards the working chamber is provided in the opening area of the second fluid line into the working chamber.

Cavitation effects which occur during the conveyance of the working fluid in the working volume frequently prove to be problematical in these stroke piston pumps. These typically result in a reduction in the amount of fluid conveyed by the pump within the stroke cycle. In extreme cases as a result of such cavitation, even individual components of the pumping device in contact with the working fluid such as, for example, valve elements or similar can be irreversibly damaged.

### SUMMARY

It is therefore an object of the present invention to provide an improved embodiment for a pumping device in which the said problems no longer occur or at most in severely restricted form.

The object is solved by the subject matter of the independent patent claims. Preferred embodiments are the subject matter of the dependent patent claims.

The basic idea of the invention is accordingly to attach both fluid lines used for discharging and introducing the working fluid into the working volume of the pumping device—hereinafter designated as “working chamber”—in the same axial end section of the working chamber. Experimental investigations have revealed that in this way flow losses in the opening area of the fluid lines into the working chamber can be reduced or even completely prevented. Since these flow losses and an associated falling below the vapour pressure in the working fluid are the essential causes of the occurrence of cavitation, these undesired cavitation effects can be prevented in this way. As a result, this leads to an improved conveying capacity and also to an increased lifetime of the pumping device.

A pumping device according to the invention comprises a working chamber which is delimited in part by a pump housing which can be filled in a known manner with a working fluid—hereinafter for simplicity designated as “fluid”. In the working chamber forming the working volume which can be filled with a fluid, a piston can be moved along an axial direction between a first position in which the working chamber has a maximum volume and a second position in which this volume has a minimum value. A first fluid line is used for introducing the fluid into the working chamber. According to the invention, the first fluid line is fluidically connected to the working chamber by means of a breakthrough which is formed in the pump housing at an end face of the working chamber opposite the piston. A first valve element for closing the first fluid line with respect to the working chamber is provided in the area of the breakthrough. Furthermore, a second fluid line also opens into the working chamber via which the fluid can be discharged again from the working chamber and specifically in the area of the second position of the piston. In the opening area of the second fluid line into the working chamber, a second valve element is provided for closing the second fluid channel towards the working chamber.

According to the invention, the second valve element communicates fluidically directly with the working chamber. According to the invention, the second fluid line opens into the working chamber in an end face delimiting the working chamber towards the first fluid line. In this way, the pumping device according to the invention can have a particularly simple structure which is associated with reduced costs.

In a preferred embodiment, the first fluid line runs transversely to the axial direction at least in the area of the breakthrough. In this way, the installation space required for the pumping device can be kept small.

Particularly preferably the first fluid line can be configured as an, in particular closed, annular fluid channel. In this way, undesired pressure losses, because they reduce the efficiency of the pumping device, can be kept small.

Particularly little installation space is required by an arrangement of the annular fluid channel in the pumping device in such a manner that the closed annular line extends in a plane perpendicular to the axial direction.

Unnecessary dead volumes can also be avoided if the first valve element communicates fluidically directly with the first fluid line.

The formation of dead volumes which reduce the efficiency of the pumping device can be counteracted in a further preferred embodiment in which the first valve element is arranged completely in the working chamber and communicates fluidically with the first fluid line directly via the breakthrough.

In a further preferred embodiment, the first valve element projects at least partially into the working chamber. In this way, flow losses, which are undesirable because they promote cavitation, can be further reduced in the area of the valve element.

In a further preferred embodiment, the opening area of the second fluid line is provided in an axial end section of the working chamber facing the first fluid line. This means that the two fluid lines open adjacently to one another into the working chamber of the pumping device. In this way, flow losses promoting the occurrence of cavitation can be restricted to a spatially limited area of the working chamber.

A further preferred embodiment in which the second fluid line opens into the working chamber in a circumferential side delimiting the working chamber and/or in an end face delimiting the working chamber towards the first fluid line has a constructively particularly simple structure and is thus associated with reduced manufacturing costs. An opening of the second fluid line in a transition region between circumferential side and end face is also possible.

In a further preferred embodiment, the second valve element forms a part of the circumferential-side and/or end-face-side delimitation of the working chamber. Experimental tests have shown that such an arrangement particularly effectively counteracts cavitation effects.

Particularly expediently, the second valve element can end substantially flush with an end face delimiting the working chamber towards the first fluid line. An undesired recess promoting the formation of cavitation can in this way be largely or even completely avoided.

Particularly expediently the first valve element is a non-return valve which is adjustable between an open and a closed position, which is adjusted from the closed into the open position when the fluid pressure in the first fluid line is greater than in the working chamber and the pressure difference exceeds a predetermined threshold value. The use of such a constructively simply constructed non-return valve has the result that flow losses in the area of the valve element can be further reduced.

Similarly to this, in a further preferred embodiment the second valve element can be a non-return valve which is adjustable between an open and a closed position. The second non-return valve is then adapted in such a manner that it is adjusted from the closed into the open position when the fluid pressure in the working chamber is greater than in the second fluid line and the pressure difference exceeds a predetermined threshold value. Accordingly, the second non-return valve can be reset into the closed position when the pressure difference again drops below said threshold value.

Experimental investigations and theoretical simulation calculations have shown that a particularly favourable flow pattern with regard to undesired cavitation formation can be produced in the working volume if the second fluid line opens obliquely into the working chamber relative to the axial direction.

The same applies for an arrangement of the first fluid line according to a further preferred embodiment in such a manner that the first fluid line lengthens the working chamber along the axial direction.

In another preferred embodiment, an orifice opening of the second fluid line into the working chamber can be arranged with regard to its axial position in such a manner that the piston specifically does not close this in its second position.

In a further preferred embodiment, the first valve element projects into the working chamber in such a manner that the remaining volume between the piston in its second position and the first valve element adopts a minimum value. This measure also counteracts undesired flow and compression losses of the fluid in the working volume.

In order to assist the introduction of fluid into the working chamber and the associated translational movement away from the opening of the first fluid line, a resilient element can be provided in the working chamber. This is preferably supported at one end on the first valve element and at the other end on the piston and thus pretensions the piston towards the first position.

If the conveying capacity desired in a specific application exceeds the conveying capacity which can actually be provided by the pumping device according to the invention, it is possible to set a plurality of pumping devices according to the invention in operative connection with one another and connect these fluidically in parallel to increase the conveying capacity.

The invention therefore also relates to a pump arrangement comprising three previously introduced pumping devices according to the invention, whose working chambers are arranged with the breakthroughs between working chamber and first fluid line in each case parallel to one another in relation to the axial direction. The arrangement of the three working chambers with the breakthroughs between the first fluid line and the working chamber has a 120° rotational symmetry in a cross-section perpendicular to the axial direction in relation to a predefined symmetry point. According to the invention, the three first fluid lines are formed as a common annular fluid channel with the already-mentioned symmetry point as the annular centre point of the annular fluid channel. In this way, the installation space required for the three pumping devices can be kept small. The symmetrical structure of the three pumping devices also has the result that when three pumping devices are fluidically interconnected, the occurrence of undesired cavitation can be largely or completely avoided.

The invention finally relates to a waste heat recovery apparatus, comprising a fluid cycle through which a working medium - a fluid - flows or can flow. A pumping device according to the invention introduced above or a previously introduced pump arrangement according to the invention comprising three pumping devices is arranged in the fluid cycle for driving the working medium.

Further important features and advantages of the invention are obtained from the subclaims, from the drawings and from the relevant description of the figures with reference to the drawings.

It is understood that the features mentioned previously and to be explained further hereinafter can be used not only in the respectively given combination but also in other combinations or alone without departing from the scope of the present invention.

Preferred exemplary embodiments of the invention are presented in the drawings and are explained in detail in the following description, where the same reference numbers relate to the same or similar or functionally the same components.

### BRIEF DESCRIPTION OF THE DRAWINGS

In the figures, in each case schematically

FIG. 1 shows an example of a pump arrangement according to the invention in a perspective view,

FIG. 2 shows a detailed view of FIG. 1 in which the structure of a pumping device 1 of the pump arrangement is shown in detail,

FIG. 3 shows a detailed view of the pumping device of FIG. 2 in the area of a working chamber 3 of the pumping device 1,

FIG. 4 shows a schematic view illustrating the tripod-like structure of the three pumping devices of FIG. 1 in schematic form.

### DETAILED DESCRIPTION

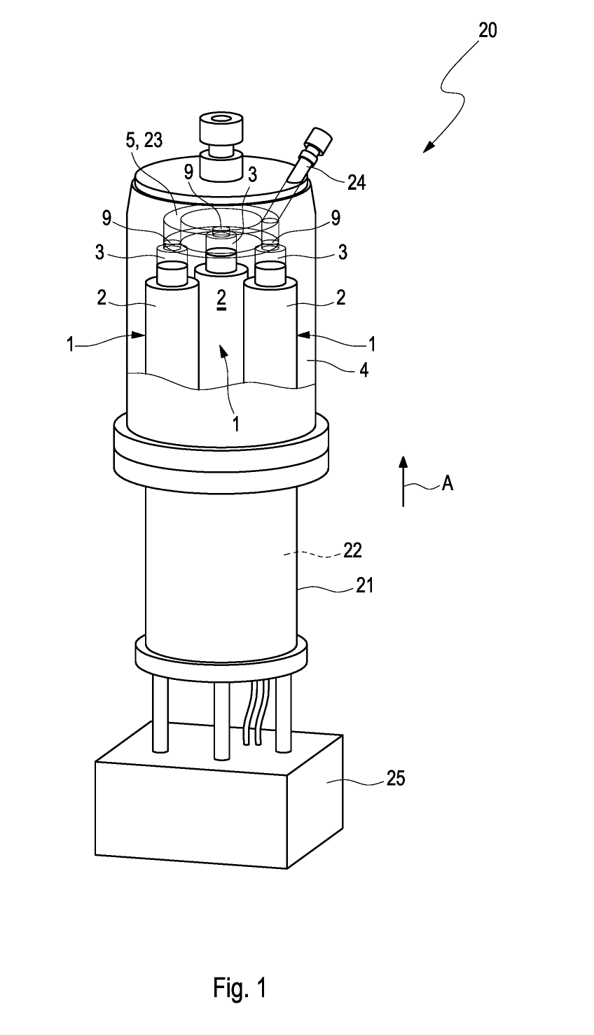

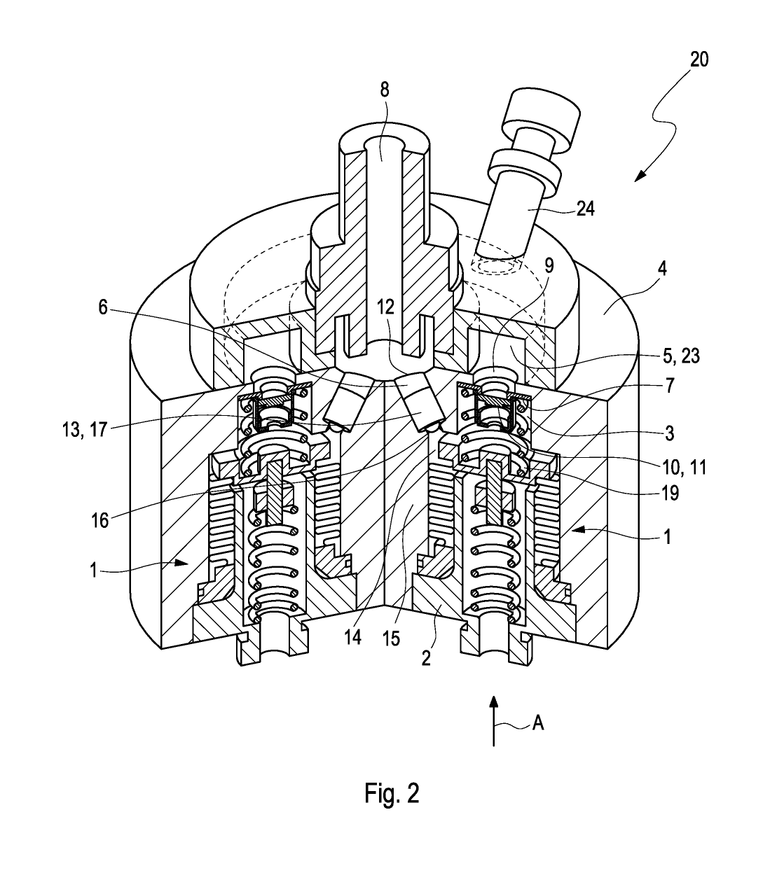

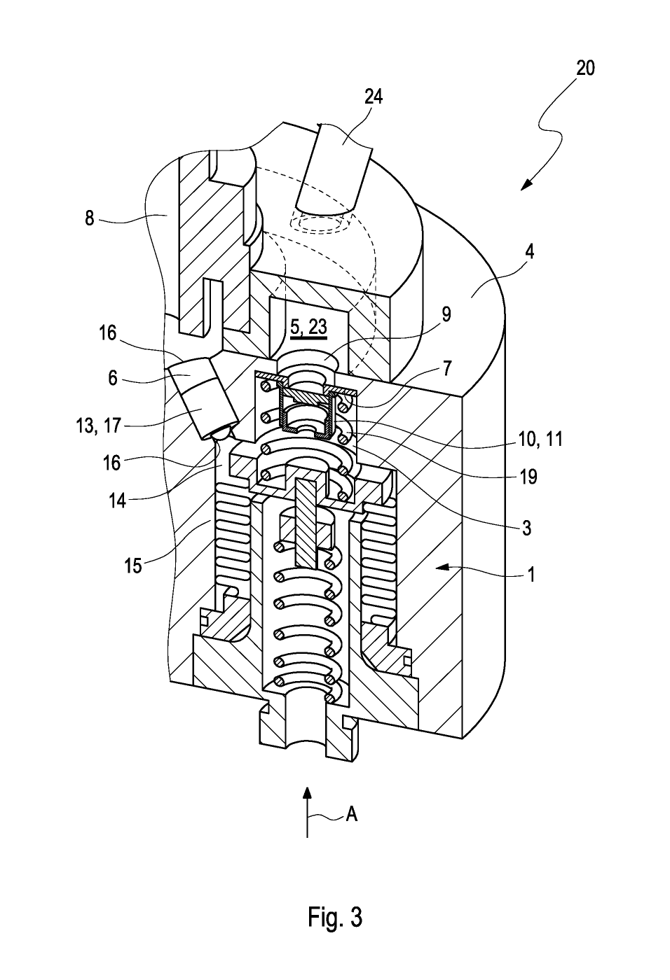

FIG. 1 illustrates in a perspective view an example of a pump arrangement 20 according to the invention. FIG. 2 shows a detailed view of FIG. 1 in which the structure of a pumping device 1 of the pump arrangement 20 is shown in detail. FIG. 3 in turn shows a detailed view of FIG. 2 in the area of a working chamber 3 of the pumping device 1.

The pump arrangement 20 comprises three pumping devices 1 each configured as stroke or axial piston pumps, which are implemented to form the pump arrangement 20 in the form of a tripod arrangement. This means that the respective pistons 2 of the three pumping devices 1 and the working chambers 3 accommodating the respective pistons 2, which are each delimited by a pump housing 4 are arranged parallel to one another in relation to their axial axis. A piston 2 which can be adjusted along an axial direction A is arranged in each of the three working chambers 3. Each of the three pistons 2 is adjustable axially between a first position in which the working chamber 3 has a maximum volume and a second position in which the working chamber 3 has a minimum volume. A common electric motor 22 which is arranged in a motor housing 21 which extends the pump housing 4 contrary to the axial direction A is used to adjust the three pistons 3. The electric motor 22 can be controlled with the aid of an electric/electronic control unit 25 which is fastened to this on a side of the motor housing 22 facing away axially from the pump housing 4.

The structure of one of the three pumping devices 1 is explained in detail hereinafter with reference to the diagram in FIG. 2:

The pump housing 4 together with the piston 2 delimits the working chamber 3 which can be filled with a fluid—the working medium of the pumping device 1. For this purpose the pumping device 1 has a first fluid line 5 which is fluidically connected to the working chamber 3 by means of a breakthrough 9. The breakthrough 9 is formed in the pump housing 4 on an end face 7 of the working chamber 3 opposite the piston 2. The first fluid line 5 runs in the area of the breakthrough 9 transversely to the axial direction A. In this case, the first fluid line 5 extends in the area of the breakthrough 9 in said plane perpendicular to the axial direction A.

In the example of the figures the first fluid line 5 is configured as a closed annular fluid channel 23 which extends completely in a plane perpendicular to the axial direction A.

Consequently the first fluid line 5 is configured to be curved in the area of the breakthrough 9.

In the area of the breakthrough 9 a first valve element 10 for closing the first fluid line 5 is provided in the working chamber 3. In one variant the first valve element 10 can be arranged in the area of the breakthrough 9 also on the side of the first fluid line 5. The first valve element 10 in one variant can also project from the first fluid line 5 through the breakthrough 9 into the working chamber 3 and specifically preferably in such a manner that the dead volume of the working chamber 3 is minimal or even has a zero value. Unnecessary dead volumes can also be avoided if the first valve element 10 communicates fluidically directly with the first fluid line 5, i.e. no intermediate space is formed between the first fluid line 5 and the first valve element 10.

The formation of undesired dead volumes can also be counteracted in the variant shown in the figures in which the first valve element 10 is arranged completely in the working chamber 3 and communicates fluidically via the breakthrough 9 directly, i.e. without forming an intermediate space, with the first fluid line 5.

In the example of the figures, the first valve element 10 is a non-return valve 11 which is adjustable between an open and a closed position. In the closed position the first valve element 10 closes the first fluid line 5 with respect to the working chamber 3 in a fluid-tight manner. In the open position the first valve element 10 releases the fluid communication between first fluid line 5 and the working chamber 3 so that the fluid can be introduced from the first fluid line 5 into the working chamber 3. The non-return valve 11 is adjusted from its closed position into its open position when the fluid pressure in the first fluid line 5 is greater than in the working chamber 3 and the pressure difference exceeds a predetermined value. This takes place by an axial movement of the piston 2 away from the breakthrough 9.

According to FIG. 2, the pumping device 1 also comprises a fluid supply line 24 for introducing the fluid into the first fluid line 5. According to FIG. 2, the first fluid line 5 extends the working chamber 3 along the axial direction A. The fluid supply line 24 opens tangentially into the first fluid line 5 configured as annular fluid channel 23. Alternatively or additionally the fluid supply line 24 can also open obliquely into the first fluid line 5. This can in particular mean that in a longitudinal section of the pumping device 1 along the axial direction A the fluid supply line 24 forms an acute angle with the plane perpendicular to the axial direction A in which the annular fluid channel 23 is arranged.

For discharging the fluid from the working chamber 3, a second fluid line 6 is provided which opens into the working chamber 3 in the area of the second position of the piston 2—this position is shown in FIG. 2 and also in the detailed view of FIG. 3. The opening area 12 of the second fluid line 6 is therefore - in the same way as the first fluid line 5 arranged on the front side—arranged in an axial end section 14 of the working chamber 3 facing the first fluid line 5. The second fluid line 6 opens into the working chamber 3 in a transition region between a circumferential wall 15 of the pump housing 4 delimiting the working chamber 3 and an end wall delimiting the pump housing 4 towards the first fluid line 5. The second fluid line 6 opens obliquely into the working chamber 3 relative to the axial direction A. An orifice opening 16 of the second fluid line 6 is arranged in relation to its axial position in such a manner that the piston 2 specifically does not close the orifice opening 16 in its second position.

Corresponding to the breakthrough 9 of the first fluid line 5, a second valve element 13 for optional fluid-tight closure of the second fluid line 6 with respect to the working chamber is also provided in the orifice area 12 of the second fluid line 6 into the working chamber 3. The second valve element 13, in the same way as the first valve element 10, is implemented as a non-return valve 17. In contrast to the first valve element 10 however it is adjusted from the closed into the open position when the fluid pressure in the working chamber 3 is greater than in the second fluid line and the pressure difference exceeds a predetermined threshold value. This takes place if the piston 2 is moved along the axial direction A towards the breakthrough 9.

In the example of the figures, the second valve element 13 which is arranged in the transition region between circumferential-side and end-face-side delimitation of the working chamber 3, forms a part of the circumferential-side and end-face-side delimitation of the working chamber 3. Ideally the second valve element 13 ends substantially flush with the end face and/or circumferential side delimiting the working chamber 3 towards the first fluid line 5. An undesired recess promoting the formation of cavitation can in this way be largely or even completely avoided.

As shown in FIGS. 2 and 3, a resilient element 19 can be provided in the working chamber 3. This is supported according to FIG. 3 at one end on the first valve element 10 and at the other end on the piston 2 and thus pre-tensions the piston 2 towards the first position.

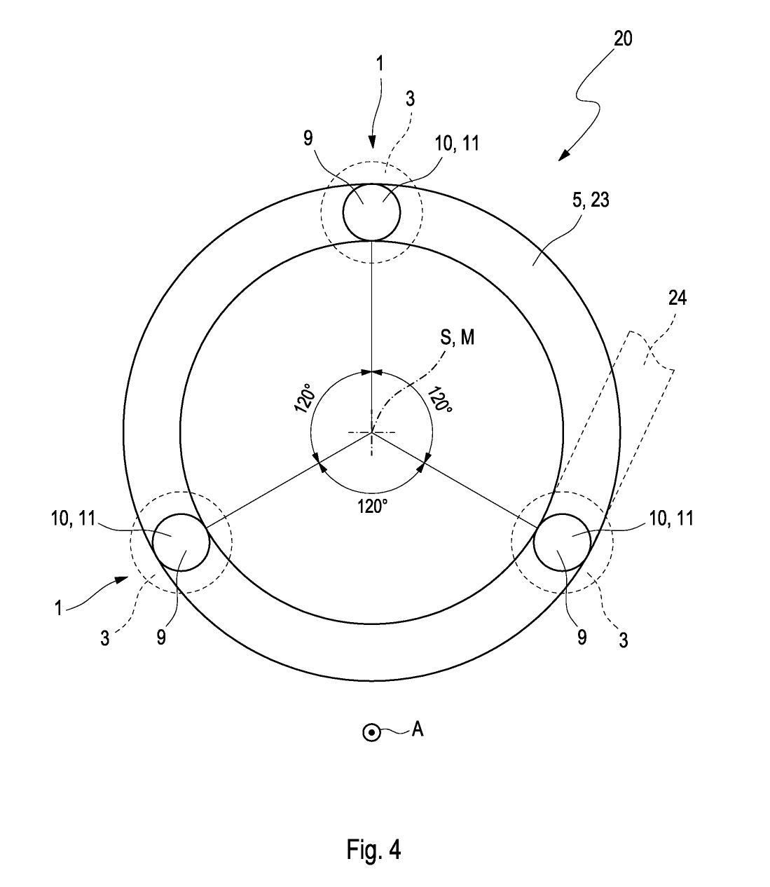

Finally, the already-mentioned tripod-like arrangement of the pump arrangement 20 is explained with reference to FIG. 4. To this end, FIG. 4 shows the structure of FIG. 2 in a cross-section perpendicular to the axial direction A in a roughly schematic view. The three working chambers 3 of the three pumping device 1—indicated by dashed lines in FIG. 4—are arranged parallel to one another along the axial direction A. As FIG. 4 clearly confirms, the arrangement of the three working chambers 3 in the cross-section perpendicular to the axial direction A exhibits a 120° rotational symmetry in relation to a predefined symmetry point S. The three first fluid lines 5 here are formed as a common annular fluid channel 23 with the symmetry point S as annular central point M. The fluid channel 23 can be arranged in a plane perpendicular to the axial direction A.

In this way, the formation of the first fluid line 5 as an annular fluid channel 23 can be used to supply the working chambers 3 of all three pumping devices 1 with the working medium in the manner described above. This ensures that the formation of undesired cavitation both in the fluid channel 23 and in the three working chambers 3 can be largely or even completely prevented.

The three second fluid lines 6 open according to FIG. 2 into a common fluid discharge line 8.

1. A pumping device for a waste heat recovery apparatus, comprising:
a pump housing partially delimiting a working chamber that is fillable with a fluid;
a piston arranged in the working chamber and movable along an axial direction between a first position in which the working chamber has a maximum volume and a second position in which the working chamber has a minimum value, volume;
a first fluid line for introducing the fluid into the working chamber;
a second fluid line for discharging the fluid from the working chamber, the second fluid line opening into the working chamber in an area of the second position of the piston;
wherein the first fluid line is fluidically connected to the working chamber via a breakthrough formed in the pump housing at an end face of the working chamber opposite the piston;
wherein a first valve for a fluid-tight closure of the first fluid line with respect to the working chamber is provided in at least one of an area of the breakthrough and the working chamber;
wherein a second valve for a fluid-tight closure of the second fluid line with respect to the working chamber is provided in an opening area of the second fluid line into the working chamber;
wherein the first fluid line runs transversely to the axial direction at least in the area of the breakthrough;
wherein the first fluid line is configured as an annular fluid channel;
wherein the second fluid line opens obliquely into the working chamber relative to the axial direction in an end face delimiting the working chamber towards the first fluid line; and
wherein the second valve communicates fluidically with the working chamber directly.

2. The pumping device according to claim 1, wherein the annular fluid channel extends in a plane perpendicular to the axial direction.

3. The pumping device according to claim 1, wherein the first valve communicates fluidically directly with the first fluid line.

4. The pumping device according to claim 1, wherein the first valve is arranged completely in the working chamber and communicates fluidically via the breakthrough directly with the first fluid line.

5. The pumping device according to claim 1, wherein the first valve at least partially projects into the working chamber.

6. The pumping device according to claim 1, wherein the opening area of the second fluid line is provided in an axial end section of the working chamber facing the first fluid line.

7. The pumping device according to claim 1, wherein the second fluid line opens in a circumferential wall circumferentially delimiting the working chamber.

8. The pumping device according to claim 1, wherein the second valve forms a part of at least one of a circumferential-side delimitation of the working chamber and an end-face-side delimitation of the working chamber.

9. The pumping device according to claim 1, wherein the second valve ends substantially flush with an end face delimiting the working chamber towards the first fluid line.

10. The pumping device according to claim 1, wherein the first valve is a non-return valve adjustable between an open position and a closed position, and is adjusted from the closed position into the open position when a fluid pressure in the first fluid line is greater than in the working chamber by a predetermined threshold value.

11. The pumping device according to claim 1, wherein the second valve is a non-return valve adjustable between an open position and a closed position, and is adjusted from the closed position into the open position when a fluid pressure in the working chamber is greater than in the second fluid line by a predetermined threshold value.

12. The pumping device according to claim 1, wherein the opening area of the second fluid line is arranged in relation to an axial position of the opening area such that the piston does not close the opening area in the axial position.

13. The pumping device according to claim 1, wherein the first valve one of projects into the working chamber or is arranged in the working chamber such that a volume between the piston in its second position and the first valve has a minimum value.

14. The pumping device according to claim 1, wherein a resilient element is provided in the working chamber, and is supported at one end on the first valve and at another end on the piston, and pre-tensions the piston towards the first position.

15. A pump arrangement, comprising
three pumping devices each having:
a pump housing partially delimiting a working chamber that is fillable with a fluid;
a piston arranged in the working chamber and movable along an axial direction between a first position in which the working chamber has a maximum volume and a second position in which the working chamber has a minimum volume;
a first fluid line configured as an annular fluid channel for introducing the fluid into the working chamber, the first fluid line being fluidically connected to the working chamber via a breakthrough formed in the pump housing at an end face of the working chamber opposite the piston, and running transversely to the axial direction at least in the area of the breakthrough;
a second fluid line for discharging the fluid from the working chamber, the second fluid line opening into the working chamber in an area of the second position of the piston, and opening obliquely into the working chamber relative to the axial direction in an end face delimiting the working chamber towards the first fluid line;
a first valve for a fluid-tight closure of the first fluid line with respect to the working chamber in at least one of an area of the breakthrough and the working chamber; and
a second valve for a fluid-tight closure of the second fluid line with respect to the working chamber in an opening area of the second fluid line into the working chamber, the second valve communicating fluidically with the working chamber directly;
wherein the working chambers of the three pumping devices are arranged with the breakthroughs parallel to one another in relation to the axial direction;
wherein the pumping arrangement of the three working chambers with the breakthroughs has a 120° rotational symmetry in a cross-section perpendicular to the axial direction in relation to a predefined symmetry point; and
wherein the first fluid lines of the three pumping devices are formed as a common annular fluid channel with the symmetry point as an annular centre point of the annular fluid channel.

16. A waste heat recovery apparatus, comprising:
a fluid cycle through which a fluid is flowable; and
one of a pumping device and a pump arrangement arranged in the fluid cycle for driving the fluid;
wherein the pumping device includes:
a pump housing partially delimiting a working chamber that is fillable with a fluid:
a piston arranged in the working chamber and movable along an axial direction between a first position in which the working chamber has a maximum volume and a second position in which the working chamber has a minimum volume;
a first fluid line configured as an annular fluid channel for introducing the fluid into the working chamber, the first fluid line being fluidically connected to the working chamber via a breakthrough formed in the pump housing at an end face of the working chamber opposite the piston, and running transversely to the axial direction at least in the area of the breakthrough;
a second fluid line for discharging the fluid from the working chamber, the second fluid line opening into the working chamber in an area of the second position of the piston, and opening obliquely into the working chamber relative to the axial direction in an end face delimiting the working chamber towards the first fluid line;
a first valve for a fluid-tight closure of the first fluid line with respect to the working chamber in at least one of an area of the breakthrough and the working chamber; and
a second valve for a fluid-tight closure of the second fluid line with respect to the working chamber in an opening area of the second fluid line into the working chamber, the second valve communicating fluidically with the working chamber directly; and
wherein the pumping arrangement includes three pumping devices arranged to have a 120° rotational symmetry in a cross-section perpendicular to the axial direction in relation to a predefined symmetry point, the first fluid lines of the three pumping devices being formed as a common annular fluid channel with the symmetry point as an annular centre point of the annular fluid channel.

17. The pumping device according to claim 2, wherein the first valve communicates fluidically directly with the first fluid line.

18. The pumping device according to claim 2, wherein the first valve is arranged completely in the working chamber and communicates fluidically via the breakthrough directly with the first fluid line.

19. The pumping device according to claim 2, wherein the first valve at least partially projects into the working chamber.

20. The pumping device according to claim 2, wherein the opening area of the second fluid line is provided in an axial end section of the working chamber facing the first fluid line.
